(19) United States
(12) Patent Application Publication
(10) Pub. No.: US 2012/0098959 A1
(43) Pub. Date: Apr. 26, 2012

(54) METHOD AND APPARATUS FOR MEASURING TRANSMITTED OPTICAL DISTORTION IN GLASS SHEETS

(75) Inventor: Jason C. Addington, Sylvania, OH (US)

(73) Assignee: GLASSTECH, INC., Perrysburg, OH (US)

(21) Appl. No.: 12/908,429

(22) Filed: Oct. 20, 2010

(51) Int. Cl. H04N 7/18; C03B 23/00; G06K 9/00

(52) U.S. Cl. 348/125; 382/141; 65/158; 348/E07.085

(57) ABSTRACT

An apparatus and associated method for measuring both transmitted optical distortion and other minimal visible defects in the surface of a glass sheet. The disclosed apparatus includes a glass stand which receives a glass sheet for mounting between a background screen which includes a pre-defined contrasting pattern, and a digital camera which captures an image of the pattern transmitted through the glass sheet. The digital image is downloaded to a computer that is suitably programmed to analyze the image data to determine (1) optical distortion indicia, including the magnification and lens power, in the observed image of the pattern transmitted through the glass sheet, and (2) small visible optical or obstructive defects on the glass sheet.

### TECHNICAL FIELD

This invention relates to a method and apparatus for measuring transmitted optical distortion in glass sheets.

### BACKGROUND

Manufacturers of glass sheets, particularly glass sheets formed into various curved shapes for use as automotive windshields, backlites, and sidelites, are interested in measuring and evaluating the amount of optical distortion in the formed sheets that might be perceived by a human observer, such as the operator or passenger in a vehicle in which the glass may be mounted as the windshield, backlite, or sidelite. Manufacturers, as well, desire to identify small marks or other defects that are visible on the surface of the form glass sheets.

### SUMMARY

The present invention provides an apparatus and associated method for measuring both transmitted optical distortion, and other minimal visible defects in the surface of a glass sheet. The disclosed apparatus includes a glass stand which receives a glass sheet for mounting between a background screen which includes a pre-defined contrasting pattern, and a digital camera which captures an image of the pattern transmitted through the glass sheet. The digital image is downloaded to a computer that is suitably programmed to analyze the image data to determine (1) indicia, including the magnification and lens power, of optical distortion in the observed image of the pattern transmitted through the glass sheet, and (2) small visible optical or obstructive defects on the glass sheet.

Various statistical information can be reported for predefined areas of the glass sheet, including the maximum, minimum, range, mean, and standard deviation in lens power, or other indices of distortion which may be of interest.

In addition to the above-described optical distortion characteristics and data identified and displayed by the system, the disclosed system and method also identifies and locates areas of optical and/or obstructive distortion and other visible, defects as small as 1 millimeter in diameter, which appear on the glass sheet surface.

The system and method of the present invention may also include an auto-zone positioning feature which has the capability of realigning image references from one part to the next. Identified edges or markings, and/or the unfiltered vertical distortion field data from a pre-defined zone, on a first piece of glass are cross-correlated with markings/distortion field data from the same zone on a subsequent glass part, yielding translational and rotational values for realigning the second glass part to achieve maximal correlation with the region in the first part. If the second part is realigned using these parameters (e.g., where there is a suitably high degree of correlation), reproducibility of system output is significantly enhanced.

The system may take the form of a stand-alone laboratory or production floor installation, or it may be installed in-line with other processing stations utilized in glass sheet processing equipment, such as automobile windshield and backlite fabrication lines.

The system may be programmed by the user to graphically and numerically display various indicia of optical distortion, including those indicia most relevant to industry standards such as ECE R43, or other indicia considered relevant in the industry to the analysis of the optical transmission quality of formed and fabricated glass sheets. The system may, as well, be programmed to display the locations of small visible surface defects identified on the glass sheet.

### BRIEF DESCRIPTION OF THE DRAWINGS

FIG. 1 is a perspective view of the disclosed apparatus;

FIG. 2 is a front view of the array sheet used in one embodiment of the disclosed system;

FIG. 2a is an enlarged view of a section of the array sheet;

FIG. 3 is a flow chart of one of the disclosed process operations performed as part of the image analysis;

FIG. 4 is a computer display screen view of the measured results for a glass windshield measured using the disclosed apparatus and method;

FIG. 5 is a computer display screen shot illustrating a depiction of vertical distortion measured in a glass windshield;

FIG. 6 is a computer display screen shot illustrating a depiction of the intensity map generated from the magnitude component of the inverse Fourier transform of the de-modulated data;

FIG. 7 is a computer display screen shot with the locations of small defects identified as a result of the image intensity map analysis superimposed on a depiction of the vertical distortion measured in a glass windshield;

FIG. 8 is a flow chart of the disclosed auto-positioning method;

FIG. 9 is a schematic diagram of one embodiment of the disclosed system installed in-line in a typical automotive backlite forming and tempering line;

FIG. 10 is a schematic diagram of another embodiment of the disclosed system installed in-line in a typical automotive windshield forming line; and

FIG. 11 is a perspective view of the disclosed apparatus installed in-line on a conveyor in a typical glass sheet forming line.

### DETAILED DESCRIPTION

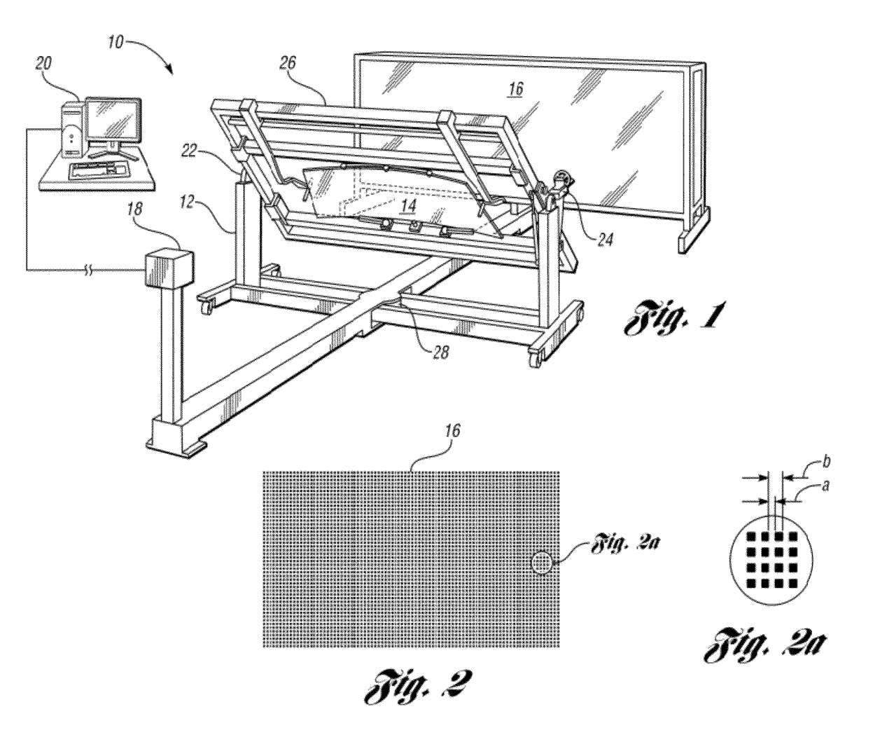

Referring to FIG. 1, in one embodiment, the system 10 includes a glass stand 12 for mounting a glass sheet 14 between a contrasting pattern displayed on a background screen 16 and a digital camera 18. The digital camera 18 is operatively connected to a conventional computer 20 to facilitate periodic downloading of image data for processing and analysis according to the disclosed method. In one embodiment, the glass stand includes first and second adjustment mechanisms 22 and 24 to allow for rotational adjustment of the mounting frame 26 about a generally horizontal axis, and third adjustment mechanism 28 to rotate the glass frame 26 about a generally vertical axis, in order to orient the glass sheet in the same position in which the glass would be installed in use in a vehicle. In one embodiment, the background screen provides pattern of dark squares positioned on a light background at a known predetermined distance from each other, forming a rectangular grid such that the image of the grid is projected onto the camera 18 through the glass sheet 14 mounted therebetween.

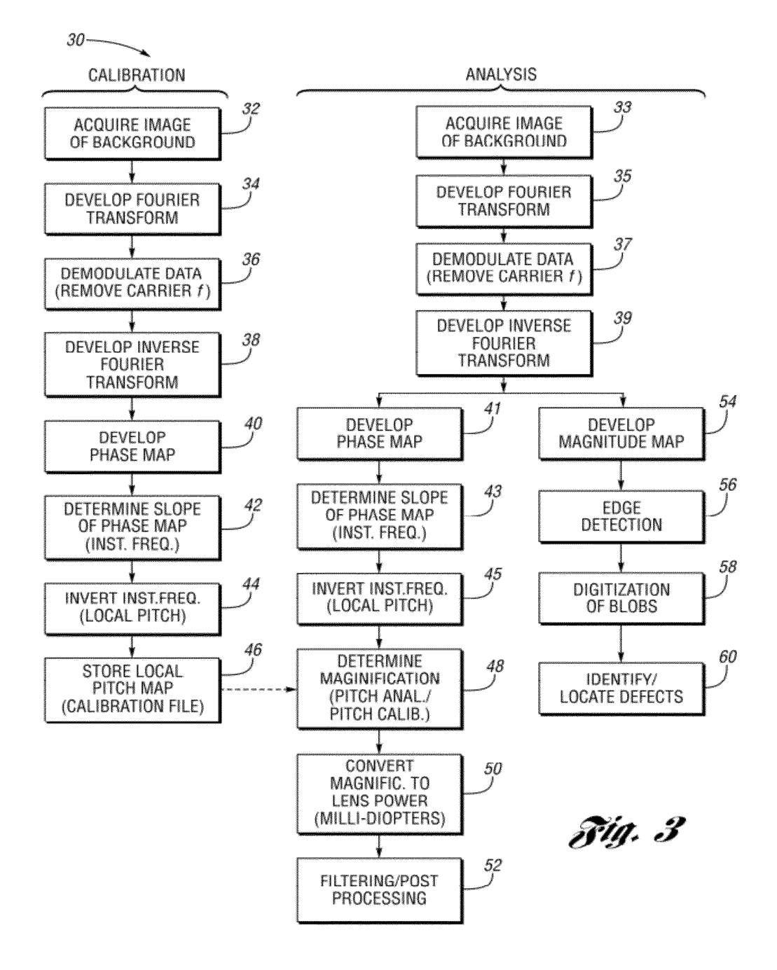

In the embodiment illustrated in FIGS. 2 and 2a, the squares on the screen 16 are arranged on a light background such that each dark square is at an equal distance from each adjacent dark square in a checkerboard pattern. In one embodiment of the system, the dark squares on the grid screen are 2.25 millimeters wide, and the distance, a, between each dark square and its immediate neighbors is 2.25 millimeter, resulting in an edge-to-corresponding-edge distance, b, of 4.5 millimeters. It will be appreciated, however that the square thickness and distances utilized in the analysis are not the actual sizes and distances measured on the screen 16, but instead are the line thickness and distance measured in an image focused at the distance between the camera and the mounting location of the glass sheet. It will also be appreciated that other similar contrasting grid patterns may be employed without departing from the spirit of the present invention.

The digital camera 18 is mounted to collect images of the grid on screen 16 transmitted through the glass sheet 14 mounted on the glass stand. In one embodiment, the digital camera is a commercially available 12.8 MPa SLR-type camera. In another embodiment of the invention, a 16 MPa, 3 frame-per-second GE4900 model CCD camera, available from Prosilica, Inc. of Burnaby, British Columbia, Canada, may be employed as the camera.

The camera 18 is connected via a conventional data line to a computer 20 which is suitably programmed to acquire the digital image data from the camera, process the image data to obtain the desired resolution for the data, and analyze the data to develop various indicia of distortion as well as small surface defects in the glass sheet according to the method of the present invention as further described herein. The computer is also programmed to present the derived image distortion information in both graphical (e.g., color-coded images) and statistical forms.

In one embodiment, the grid screen is a light box that utilizes conventional lighting (such as fluorescent lights) behind a translucent panel upon which a contrasting pattern, preferably in the form of a black-square-on-white background grid, is printed, painted, or otherwise applied using conventional methods. The digital camera is connected to the computer using known methods, preferably so that the acquisition of the image by the camera may be controlled by the computer.

The computer 20 is programmed to perform the image acquisition, modification and analysis steps described hereinafter for each glass sheet to be measured, as well as to display the resulting distortion indicia in graphical and/or numeral formats.

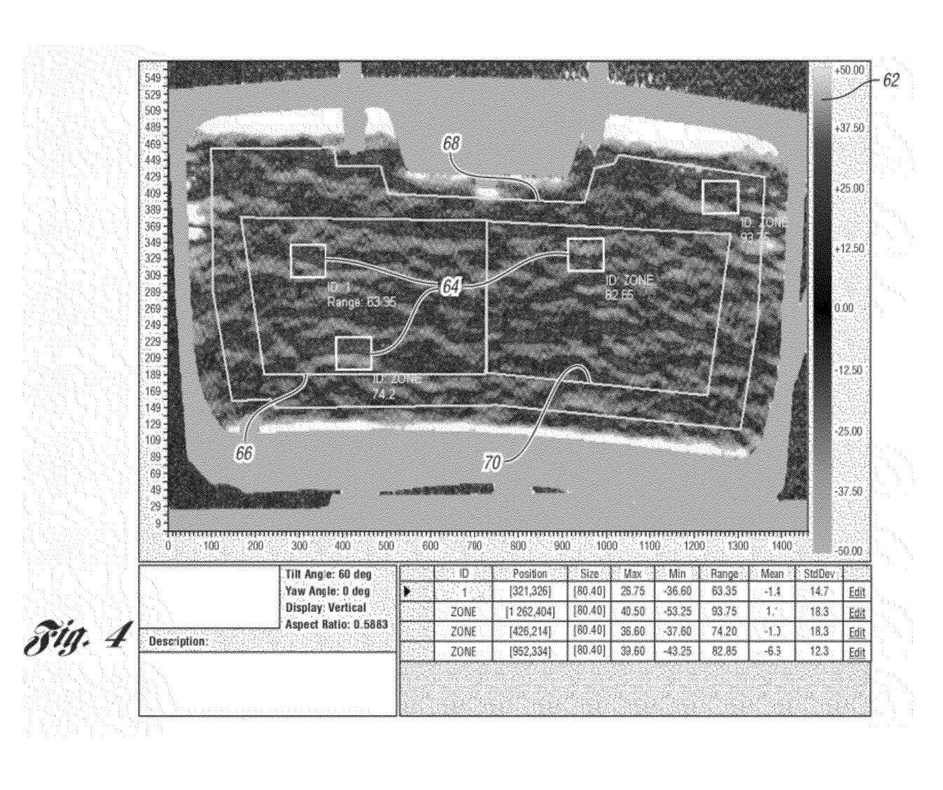

The principal image distortion analysis process is charted in FIG. 3. According to the disclosed method 30, the system is first calibrated at steps 32-46. Calibration begins, at 32, by acquiring an image of the background using a CCD camera without a test piece of glass mounted between the camera and the background. At 34, a Fourier transform of the acquired calibration image data is developed. The resulting data is modulated by the fundamental frequency of the grid pattern on the screen in both the horizontal and vertical directions. The bandwidth is narrowed to eliminate unwanted signal data such as second harmonics. At 36 the transformed data is demodulated, to remove the carrier frequency. An inverse Fourier transform of the demodulated data is then developed, at 38, with the resulting data yielding a two-dimensional complex number associated with each pixel having a phase component and a magnitude component. A phase map of the inverse Fourier transform is then developed, at 40, by computing the inverse tangent of the imaginary portion of the two-dimensional complex number divided by the real portion of the two-dimensional complex number for each pixel in the image.

The slope of the phase map is representative of the instantaneous frequency at each pixel in the image. These values are developed at 42. At 44, the instantaneous frequency at each pixel is inverted to obtain the local pitch. This local pitch map is then stored, at 46, as the calibration file. This calibration file is then used in the analysis of the phase portion of the images acquired for each glass sheet subsequently tested using the system.

The analysis for each glass sheet is illustrated at steps 33-60 in FIG. 3. Once the piece is mounted for analysis, the initial steps, indicated at 33-45, are identical to steps 32-44 described above, except that an image of the background screen is acquired, at 33, using a CCD camera with the subject glass part (the “test part”) positioned between the camera and the background screen. The resolved image data is then processed as further described below to develop the optical distortion indicia, as well as to identify and locate the small optical and obstructive defects visible on the glass sheet.

The optical distortion indicia for the glass test part is developed as shown in steps 41-52 of FIG. 3. Once the local pitch as determined for in the test part image, at 45, the system, at 48, determines the magnification at each pixel by dividing the local pitch of the test part image by the local pitch of the calibration image at each respective pixel. These pixel-by-pixel values are then utilized, at 50, to develop a lens power (focal length) value for each pixel in the image of the test part. The lens power is typically expressed in millidiopters, the quantity often used in the glass industry for this measurement. The system proceeds in a stepwise fashion to determine magnification and lens power values for each of the dots in the image. The lens power may then also be resolved into its vertical and horizontal components.

Referring again to FIG. 3, the digital image data acquired from the camera is resolved, or filtered, at a post-processing step 52, to eliminate noise, reduce resolution of the image to that approximating how the image would be perceived by a human viewer, and/or otherwise reduce the amount of image data as desired to eliminate unnecessary processing time. Various known filtering techniques, such as data averaging, may be employed to resolve the data. In one embodiment, two standard filters are developed to provide data which has been empirically shown to correlate with the “4-5-6” and “4-5-12” filters used on another optical distortion measuring system currently available from ISRA Surface Vision GmbH, so as to allow industry users to develop comparable distortion indicia for their products regardless of which measuring system is used. The bandwidth is narrowed to eliminate unwanted signal data such as second harmonics.

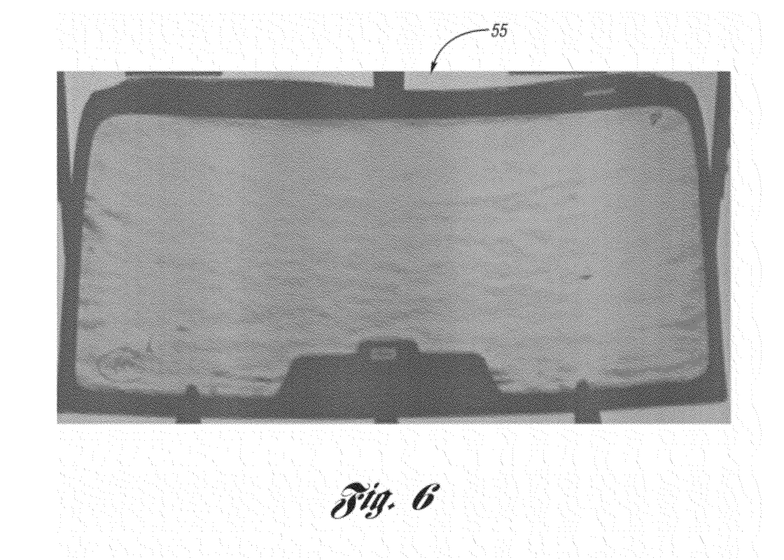

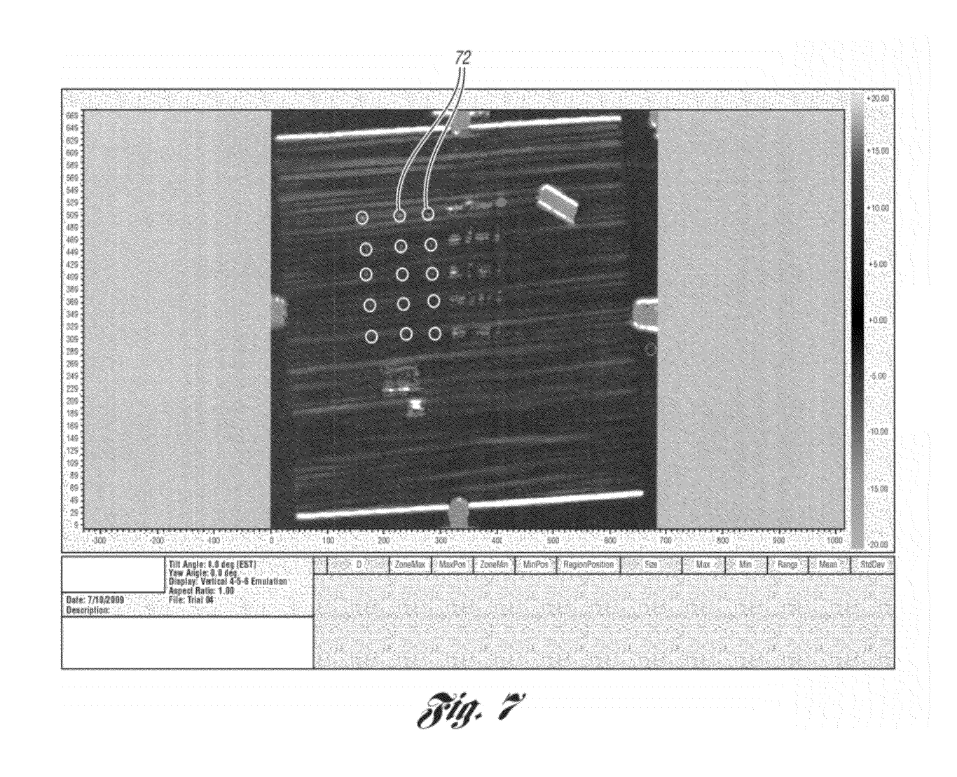

Still referring to FIG. 3, the inverse Fourier transform of the magnitude component of the complex number, developed at 39 (as described above in connection with step 38), is further developed, at 54, to yield data corresponding to an intensity map of the image. This is accomplished by determining the square root of the sum of the squares of the imaginary portion of the two-dimensional complex number and the real portion of the two-dimensional complex number for each pixel in the image. An example of this intensity (or magnitude) map, shown at 55 in FIG. 6, is similar to a gray-scale image of the glass sheet illuminated by a point source of light, including intensity discontinuities correspond to small blobs (binary large objects), corresponding to optical or obstructive defects on the glass sheet. This intensity map is analyzed, at 56, using conventional edge detection algorithms to locate the edges of the blobs. One type of edge detection algorithm that may be used for this purpose is the Canny algorithm. Once the edges of the blobs are detected, all blobs satisfy a predefined size threshold are then digitized, at 58, to identify the centers of these selected blobs. The typical “small defects” desired to be identified corresponds to blobs ranging in diameter from about 10 to about 300 pixels (i.e., 1-5). The predefined defect size may be specified by the system user. For example, one defect size range has been set to 10-200 pixels. Each of the small defects satisfying the predefined criteria are located at 60. As shown in FIG. 7, the location of each of these small visible surface defects may then be displayed on the vertical and horizontal distortion images displayed by the system. Surface defects/spots as small as 1 mm may be detected using this analysis.

Thus, both the optical distortion characteristics and other small optical/obstruction defects can be developed and identified for a particular glass sheet by isolating and analyzing, respectively, the phase and magnitude components of the inverse Fourier transform of the data acquired from a single digital image of the sheet.

In one embodiment, the system calculates and displays the lens power data associated with various predefined zones on the glass sheet. In particular, ECE R43 specifies various zones of interest on automotive windshields and backlites for which distortion data thresholds are measured and analyzed. In the table shown in FIG. 4, for example, various lens power data is provided in millidiopters for each zone, including the maximum lens power (positive magnification), minimum lens power (negative magnification), range (the difference between the identified maximum and minimum lens powers), mean lens power, and standard deviation. While ECE R43 zones are defined, the user may also define other zones of interest as desired.

One embodiment of the disclosed system and method also provides a graphical, color-coded display of the distortion using the measurement data developed for the displayed glass sheet. For example, as illustrated in FIG. 4, all areas having positive lens power are shown in red (relatively dark gray in grayscale), those areas having a negative lens power are shown in green (relatively light gray in grayscale), and those areas having zero lens power (no distortion) are shown in black. When displayed in color, the spectrum of colors corresponding to the various ranges of lens power are displayed on a color band 62 at the right on the screen.

Various statistical data may be developed for predefined regions 64 and predefined zones 66-70 in the glass sheet. FIG. 4 illustrates a region 64 utilized in one embodiment of the invention. The size and shape of the region 64 may be defined by the user depending upon the desired precision and amount of derived information, and/or processing constraints. In one embodiment, a region size of 40 millimeters by 80 millimeters is used.

The region is moved in a stepwise fashion through the zone so that each point (or pixel) in the zone is included in at least one of the region processing steps. At each step, each point in the region is accessed to determine the maximum lens power and the minimum lens power for all the points in the region, as well as the range (the difference between the maximum lens power and the minimum lens power) for those points. At the next step, the region is moved within the zone to include one or more new points and the maximum, minimum and range are determined for all the points in the region at its new location. This process is repeated until all the points in the zone have been included in the region for at least one step of the regional processing steps. It will be appreciated that the region can be repositioned within the zone at each step by any distance, as desired by the user, so long as all the points within the zone are located within the region during at least one of the processing steps. In one embodiment, the region is moved through the zone one pixel at a time, so that each point in the zone is, for example, the topmost, leftmost point in the region at a particular processing step. Of course, processing time can be reduced by moving the region so as few points as possible are included in the region in more than one processing step. For example, if the region was suitably sized and shaped to include one quarter of the points within a zone at each step, minimal processing time could be achieved by moving the region to a position in which it contains no points processed in the previous step (i.e., moving the region to each of the four locations including one quarter of the dots within the zone) so that each point is included in only one regional processing step.

In the embodiment illustrated in FIG. 4, once processing has been completed for a particular zone, the relevant distortion indicia, and the location of the region within the zone, are displayed for that region which has the greatest range (i.e., the greatest difference between its maximum lens power and its minimum lens power). Thus, when a particular glass sheet is completely processed utilizing the method illustrated in FIG. 4, a single region will be identified in each of the zones of the glass sheet, with the identified regions representing the location and value of the maximum lens power range for that zone. It will be appreciated that other optical distortion indicia can be calculated, identified, and displayed by region and/or for each zone, as desired by the user.

Referring again to FIG. 4, various distortion indicia are developed for predefined zones 66-70. In one embodiment of the system, the image distortion value associated with each point is the lens power in millidiopters, and the distortion indicia includes the maximum lens power, the minimum lens power, the range (i.e., maximum minus minimum lens power) the mean, and the standard deviation for each ECE R43 zone on the glass sheet thereby providing the analysis and data used to measure the optical quality of glass according to current defacto international standards. Of course, it will be appreciated that other distortion and indicia may be developed using the techniques of the present invention. Similarly, other zones of interest may be defined on the glass sheet as desired, depending upon industry standards, design concerns, and/or the nature of the use of the glass sheet.

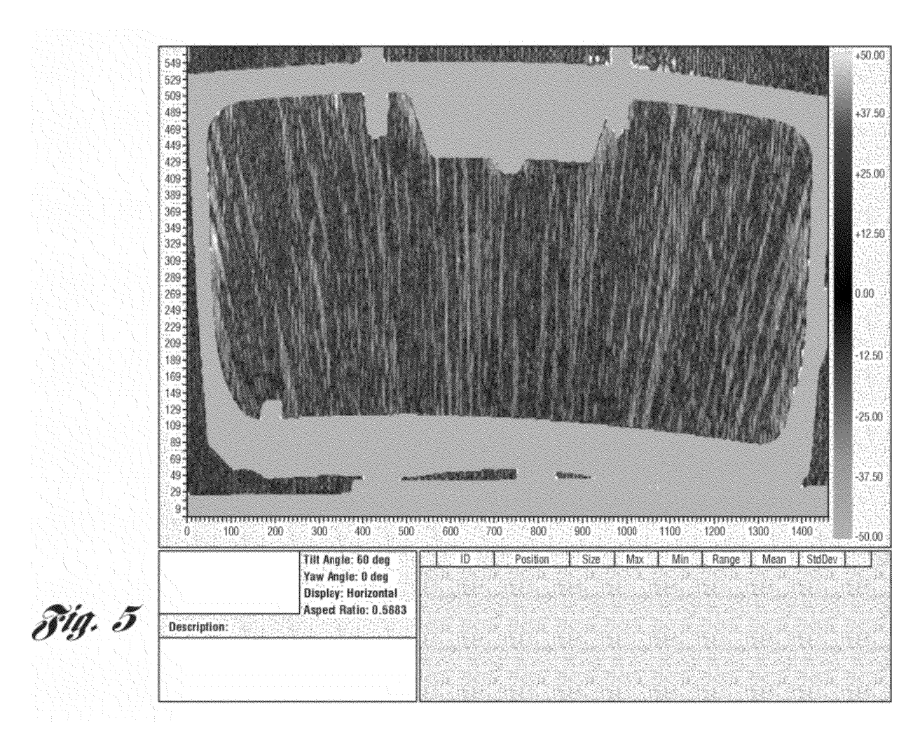

As illustrated in FIGS. 4 and 5, data and graphical displays relating only to horizontal distortion, or only to vertical distortion, can be similarly provided for each glass sheet. It should be noted that the distortion often characterized by those in the art as “horizontal” distortion, illustrated in FIG. 4, is actually distortion indicia relating to the vertical component of the variation in the distances between the dots and the distorted image and an undistorted image. Similarly, the distortion often characterized by those skilled in the art as vertical (or drawline) distortion, illustrated in FIG. 5, actually depicts the horizontal component of the variance in the distance between the dots from the distorted image (viewed through the glass sheet) and an undistorted image of the dot array screen.

In addition to the above-described optical distortion characteristics identified and displayed by the system, the system and method may also identify and locate points of optical distortion or visible or obstructive defects as small as 1 millimeter viewable on the glass sheet surface. Referring to FIG. 7, the locations of small defects detected on the glass sheet may be identified, such as by superimposing highlighted circles 72 surrounding each defect, on computer displays illustrating other optical distortion characteristics of the glass sheet.

The disclosed system may also include an auto-zone positioning feature which realigns image references from one part to the next to compensate for linear misalignment of up to 2 inches and rotational misalignments of up to 5 degrees. Referring to FIG. 8, an identifiable location-specific characteristic is identified on a first piece of glass at 74. At 75, the system attempts to cross-correlate the same characteristic from the same zone on images corresponding to subsequent parts of the same shape. If, at 76, the characteristic is identified in a subsequent part at a location within a pre-defined distance from the location of the characteristic of the initial part, translational and rotational values are developed, at 77, for realigning the subsequent glass part to achieve maximal correlation with the region in the first part. If the second part is realigned using these parameters (e.g., where there is a suitably high degree of correlation), reproducibility of system output is significantly enhanced.

In one embodiment of the system, the unfiltered vertical distortion field data from a pre-defined zone of the image is cross-correlated with the same data from the same zone on a subsequent glass part. Alternatively, or additionally, other location-specific characteristics, such as an edge of the glass, or the edge of a paint band, may be identified and cross-correlated to develop the desired part-to-part realignment values.

In the embodiment shown in FIG. 1, the system 10 is provided as a stand-alone product which may be located in an engineering laboratory or production environment. Other contemplated embodiments of the system 10 include in-line installations in glass sheet processing systems, whereby the optical distortion may be measured for each glass sheet as it is conveyed through the fabrication process.

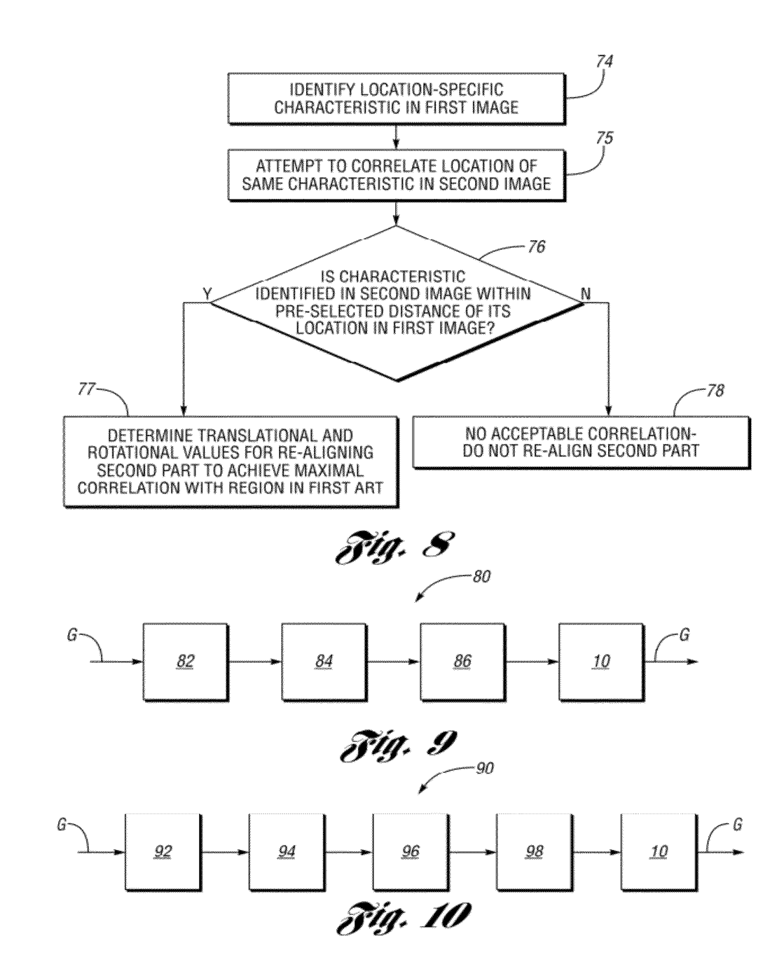

For example, FIG. 9 illustrates a typical automotive backlite heating, bending, and tempering system 80 which includes the system 10 of the present invention in-line. In this installation, the glass sheets (indicated as G) enter a heating zone 82 where the glass is softened to a temperature suitable for forming the glass into the desired shape. The heated glass sheet is then conveyed to a bending station 84 where the softened sheet is formed to the desired shape, and thereafter further conveyed to a cooling station 86 where the glass sheet is cooled in a controlled manner to achieve the appropriate physical characteristics. In this embodiment, the glass sheet would then be conveyed out of the cooling station to a transport position from which the sheet is moved from the conveyor and mounted on the glass stand for image acquisition and analysis according to the present invention. Following the measurement, the glass sheet would then be removed from the stand and deposited on a conveyor, or in a storage rack, for further processing. It will be appreciated that the transport and conveyance of the glass can be achieved by using known techniques such as by roller, air-float, or belt conveyors, positioners, and robotic arms, in order to handle the glass in the manner described.

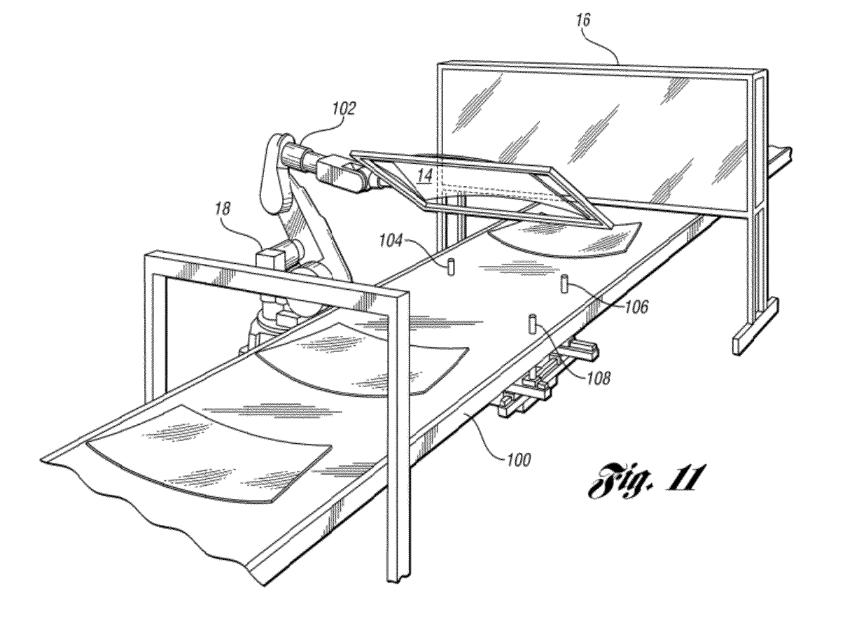

FIG. 10 similarly schematically illustrates an in-line installation of the system 10 of the present invention in a typical windshield fabrication system 90, which may include a heating station 92, a bending station 94, a cooling station 96, and a lamination station 98, upstream of the measuring system 10. It will be appreciated that the measuring system 10 of the present invention could alternatively be mounted in-line at various other points in glass sheet fabrication systems as desired to maximize the production rate of the system, so long as the optical distortion measurements are taken after the glass sheet has been formed to its final shape.

FIG. 11 is a graphic illustration of the system 10 integrated in-line on the conveyor at the exit of a glass sheet bending system, such as those described in FIGS. 9 and 10. Glass is typically conveyed from the cooling section of a bending and tempering/annealing system by use of a belt or roller conveyor, shown in FIG. 10 as conveyor 100, for various secondary processing operations, such as post-forming and soldering for heater grid and other electrical connections, as well as for other inspection operations, such as shape analysis. The system 10 of the present invention may be integrated in-line by arranging the camera 18 and the background array 16 such that, each glass sheet 14 may be picked up by a robotic arm 102 when it reaches a pre-defined position on the conveyor and oriented in the path between the camera 18 and the screen 16 at the desired tilt angle. The image of the array is then acquired and analyzed as previous described to determine magnification, lens power, and other desired statistical information.

After the image of the glass sheet is acquired, the robotic arm 102 is controlled to re-position the glass sheet on the conveyor, and the process is repeated for other selected glass sheets as they move along the conveyor from the exit of the heating, bending and cooling system to one or more post processing stations as described above.

As shown in FIG. 11, positioning stops 104,106, 108 may be located to accurately position the glass sheet as it moves on the conveyor into position for retrieval by the robot arm. It will be appreciated by those skilled in the art that various known positioning apparatus may be employed for this purpose. Similarly, although the camera and array screen are arranged in the illustrated embodiment such that the path between the camera 18 and background array 16 is parallel to the direction of conveyance of the glass, various alternative arrangements of the system 10 along the conveyor 100 may be employed without departing from the spirit of the invention.

In one embodiment the distortion indicia is formatted and stored in Microsoft Excel® format for ease of further review and manipulation by the user.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for measuring optical characteristics of a glass sheet including:
a digital camera,
a background screen including contrasting elements arranged in a pre-defined pattern,
a glass stand for receiving and maintaining the glass sheet in the path between the camera and the background screen so that the camera captures an image of the pattern transmitted through the glass sheet,
a computer including logic for receiving captured image data associated with a selected glass sheet and (1) determining selected indicia of optical distortion associated with each point of interest on the image, and (2) identifying and locating small optical or obstructive defects on the glass sheet.

2. The apparatus of claim 1 wherein the computer includes logic for developing a phase map from the image data, and wherein the selected indicia of optical distortion are developed from the phase map.

3. The apparatus of claim 2 wherein the logic for developing a phase map from the image data includes logic for developing a Fourier transform of the captured image data, de-modulating the Fourier transform, developing an inverse Fourier transform of the de-modulated data, yielding a two-dimensional complex number associated with each point of interest, said complex number having a phase component and a magnitude component, and developing a phase map of the inverse Fourier transform by determining the inverse tangent of the imaginary portion of the two-dimensional complex number divided by the real portion of the two-dimensional complex number for each point of interest in the image.

4. The apparatus of claim 3 wherein the selected indicia of distortion includes lens power, and wherein the lens power is developed for each point of interest in the image by determining the slope at each such point in the phase map to obtain the instantaneous frequency, inverting the instantaneous frequency at each such point to obtain the local pitch, developing the magnification at each such pixel from the local pitch data, and developing the lens power from the magnification.

5. The apparatus of claim 1 wherein the computer includes logic for developing an intensity of map from the image data, and wherein the small defects are identified and located from the intensity map.

6. The apparatus of claim 5 wherein the logic for developing an intensity map from the image data includes logic for developing a Fourier transform of the captured image data, de-modulating the Fourier transform, developing an inverse Fourier transform of the de-modulated data, yielding a two-dimensional complex number associated with each pixel, said complex number having a phase component and a magnitude component, and developing an intensity to map of the inverse Fourier transform by determining the square root of the sum of the squares of the imaginary portion of the two-dimensional complex number and the real portion of the two-dimensional complex number for each point of interest in the image.

7. The apparatus of claim 6 wherein the small defects are identified and located for each point of interest in the image by analyzing the intensity map to locate the edges of small blobs.

8. A method for measuring optical distortion in a glass sheet including:
capturing a digital image of a background screen including contrasting elements arranged in a pre-defined pattern by aiming a camera at the background screen with the glass sheet position in the light path between the camera and the background screen so that the image is transmitted through the glass sheet,
receiving the captured image data and analyzing the data to (1) determine selected indicia of optical distortion associated with each point of interest on the image, and (2) identify and locate small surface defects on the glass sheet.

9. The method of claim 8 including developing a phase map from the image data, and wherein the selected indicia of optical distortion are developed from the phase map.

10. The method of claim 8 wherein the step of developing a phase map from the image data includes developing a Fourier transform of the captured image data, de-modulating the Fourier transform, developing an inverse Fourier transform of the de-modulated data, yielding a two-dimensional complex number associated with each point of interest, said complex number having a phase component and a magnitude component, and developing a phase map of the inverse Fourier transform by determining the inverse tangent of the imaginary portion of the two-dimensional complex number divided by the real portion of the two-dimensional complex number for each point of interest in the image.

11. The method of claim 8 including the step of wherein the selected indicia of distortion includes lens power, and wherein the lens power is developed for each point of interest in the image by determining the slope at each such point in the phase map to obtain the instantaneous frequency, inverting the instantaneous frequency at each such point to obtain the local pitch, developing the magnification at each such pixel from the local pitch data, and developing the lens power from the magnification.

12. The method of claim 8 including developing an intensity of map from the image data, and wherein the small defects are identified and located from the intensity map.

13. The method of claim 12 wherein the intensity map is developed from the image data by developing a Fourier transform of the captured image data, de-modulating the Fourier transform, developing an inverse Fourier transform of the de-modulated data, yielding a two-dimensional complex number associated with each pixel, said complex number having a phase component and a magnitude component, and developing an intensity to map of the inverse Fourier transform by determining the square root of the sum of the squares of the imaginary portion of the two-dimensional complex number and the real portion of the two-dimensional complex number for each point of interest in the image.

14. The method of claim 13 wherein the small defects are identified and located for each point of interest in the image by analyzing the intensity map to locate the edges of small blobs.

15. In a system for fabricating glass sheets including a heating station for heating the glass sheet to a temperature adequate to soften the glass for forming into a desired shape, a bending station wherein the softened sheet is formed to the desired shape, a cooling station wherein the formed glass sheet is cooled in a controlled manner, and one or more conveyors for conveying the glass sheet from station to station during processing, an apparatus for measuring optical characteristics of a glass sheet including:
a digital camera,
a background screen including contrasting elements arranged in a pre-defined pattern,
a glass positioner for receiving and maintaining the glass sheet in the path between the camera and the background screen so that the camera captures an image of the matrix transmitted through the glass sheet,
a computer including logic for receiving captured image data associated with a selected glass sheet and (1) determining selected indicia of optical distortion associated with each point of interest on the image, and (2) identifying and locating small surface defects on the glass sheet.
